(19) United States
(12) Patent Application Publication
(10) Pub. No.: US 2013/0148220 A1
(43) Pub. Date: Jun. 13, 2013

(54) Motorcycle Helmet Mirror

(71) Applicant: Roger D. Garrels, Sun City West, AZ (US)

(72) Inventor: Roger D. Garrels, Sun City West, AZ (US)

(21) Appl. No.: 13/313,955

(22) Filed: Dec. 7, 2011

(51) Int. Cl. G02B 7/182

(52) U.S. Cl. 359/880

(57) ABSTRACT

A mirror assembly for a motorcycle helmet includes an elongated shell having a partially-enclosed space for housing a mirror that is pivotally secured therein, and which reflects an image of the view behind the motorcyclist. The backing of the mirror and the inner surface of the shell are joined together by a ball and socket joint, permitting adjustment of the mirror orientation within the shell. A substantially rigid support arm is rigidly secured to the shell at one end, and includes a mounting pad at the opposite end. An adhesive layer secures the mounting pad to a portion of a motorcycle helmet or its associated face shield. The mounting pad may include one or more grooves to flex and conform to a curved surface.

### BACKGROUND OF THE INVENTION

1. Field of the Invention

The present invention relates generally to equipment used by motorcycle riders, and more particularly, to mirrors used to supplement a rider's view of the area behind the rider.

2. Description of the Relevant Art

Motorcycles have, for many years, provided an economical alternative to more-expensive vehicles to fulfill transportation needs. Indeed, in several Asian countries, motorcycles are the predominant method of transportation. In recent years, motorcycles have become extremely popular for weekend recreation, as well. It is estimated that, within the U.S., registrations of licensed motorcycles increased by more than 50% between 2000 and 2005, up to over 5 million registered motorcycles, according to the Insurance Institute for Highway Safety. Unfortunately, the number of deaths involving motorcycle accidents is also increasing.

Motorcyclists need to be able to visualize traffic behind them, particularly in preparation for lane changes. Likewise, in competitive off-road racing, cyclists need to know whether other riders are behind them, and how close or distant they are. Federal Motor Vehicle Safety Standards issued by the U.S. Department of Transportation require that all motorcycles sold for use on highways in the U.S. have at least one rear view mirror; see 49 C.F.R. §571.111, “Standard No. 111; Rearview mirrors, S10. “Requirements for motorcycles”. Use of such mirrors requires either that a rider rely upon peripheral vision to monitor the image reflected by such mirror, or that the rider periodically turn his or her head to look directly at one of such mirrors. Peripheral vision is not always reliable, particularly when the handle-mounted rear view mirror must be mounted approximately 11 inches or more outward of the longitudinal centerline of the motorcycle to comply with the aforementioned federal regulations. On the other hand, riders who turn their heads to look directly into such rear view mirrors are diverting their attention from the road ahead. A further disadvantage of handlebar-mounted mirrors is that vibrations from bumpy roads are communicated by the handlebars to such mirrors, resulting in an unsteady image that may be difficult to see.

For many years, there have been numerous attempts to supplement a motorcycle rider's view to the rear. For example, in U.S. Pat. No. 3,594,069 to Harvey, a one-piece rear view mirror face shield is disclosed providing a mirrored strip near the bottom of a motorcycle helmet face shield. In U.S. Pat. No. 3,804,495 to Rayow, et al., and in U.S. Pat. No. 3,978,526 to Mitchell, et al., rear vision reflection devices are disclosed for use with motorcycle helmets using a periscope-like arrangement of mirrors. A similar rear view helmet device is disclosed in U.S. Pat. No. 4,385,811 to Nava wherein one or more optical lenses are used instead of mirrors.

In U.S. Pat. No. 4,651,357 to Gershoni, a rear view mirror device is disclosed for side mounting to the face shield of a motorcycle helmet or to a helmet shell. Gershoni's rear view mirror device is either integral with the face shield or separately secured. A narrow mirrored surface is provided within such device. Once the device is secured to a face shield or helmet, no further adjustment of the mirrored surface can be made.

U.S. Pat. No. 5,432,960 to Kraut discloses helmet mirror attachments wherein a first housing is secured to the chin guard area of a helmet by an attachment screw passing through the helmet. This first housing may be rotated about the attachment screw to a desired angle, and a second screw is then tightened to lock the first housing at a desired angle. A second housing containing a mirror is mounted atop the first housing by an adjustment screw. The second housing can be rotated about the axis of the adjustment screw relative to the first housing for allowing the second housing, including the mirror housed therein, to swing outwardly or inwardly. While appearing to be rugged and aerodynamic, the disclosed device requires a screwdriver to make further angular adjustments to the mirror following initial installation.

U.S. Pat. No. 5,917,667 to Turner discloses a helmet mirror for attachment to the face shield of a helmet, or to the helmet itself. The mirror assembly includes an attachment piece for adhesive attachment to a helmet or to the face shield of a helmet. A mirror housing is pivotally connected to the attachment piece, either directly by a stud having a spherical end received within a socket of the mirror housing, or by an intermediate link that is pivotally coupled at one of its ends to the attachment piece, and pivotally coupled at its opposite end to the mirror housing. Wind resistance created when a rider is riding a motorcycle at high speeds bears directly against the mirror housing, and may further pivot the mirror housing relative to the helmet, thereby displacing the mirror housing from an initial desired angular position.

U.S. Pat. No. 6,052,832 to Crompton discloses rear view mirror assemblies for use by an off-road motorcycle rider. A mirror is pivotally coupled to a series of three brackets that are pivotally connected to each other and to the rider's helmet.

U.S. Pat. No. 6,247,824 to Berke et al. discloses a mirror system for attachment to the top of a motorcycle helmet face shield. Mirrors extend from opposing sides of a main body and are secured to extension arms by ball and socket joints. In turn, the extension arms pivot within the main body in a generally horizontal plane between extended and retracted positions.

Thus, there have been many attempts to supplement a motorcycle rider's view to the rear, but all of the devices described above suffer from one or more disadvantages. In many instances, the mirror and/or its surrounding housing can be displaced from an initially adjusted angular position due to wind forces created when riding at highway speeds. In other instances, the mirrors are not likely to be dislodged by wind forces, but further angular adjustments are impossible, impractical and/or inconvenient, often requiring the use of tools. Still other helmet-mounted rear view mirrors require the drilling of holes within, or other modifications, to the helmet and/or face shield.

Accordingly, it is an object of the present invention to provide a mirror assembly for a motorcycle rider that may easily be secured to either a motorcycle helmet itself or to the face shield of a motorcycle helmet.

It is another object of the present invention to provide such a mirror assembly that does not require modification of either a motorcycle helmet or its associated face shield, and which is easily secured thereto.

A further object of the present invention is to provide such a mirror assembly which is immune to being displaced by wind forces, even when a cyclist is riding at highway speeds.

A still further object of the present invention is to provide such a mirror assembly wherein fine adjustments to the angular orientation of the mirror can easily be performed after installation without the need for any tools.

Yet another object of the present invention is to provide such a mirror assembly which is of simple and inexpensive construction.

These and other objects of the present invention will become more readily apparent to those skilled in the art as the description of the present invention proceeds.

### SUMMARY OF THE INVENTION

Briefly described, and in accordance with a preferred embodiment thereof, the present invention relates to a mirror assembly for a motorcycle helmet and including an elongated shell for housing a mirror. The shell includes a peripheral portion, preferably of generally rectangular shape. This peripheral portion surrounds a central portion of the shell which projects forwardly of the peripheral portion of the shell. The shell includes a forwardly-facing outer surface having a generally convex shape and an opposing rearwardly-facing inner surface having a generally concave shape that defines a partially-enclosed space.

A mirror is disposed within the partially enclosed space of the shell, and is coupled thereto, for reflecting an image of the view behind a motorcyclist. The mirror includes a mirrored surface that faces away from the inner surface of the shell. In the preferred embodiment, the mirror includes a backing that faces toward the inner surface of the shell. Ideally, the backing of the mirror and the inner surface of the shell are joined together by a ball and socket joint for securing the mirror within the partially enclosed space of the shell while permitting adjustment of the orientation of the mirror relative to the shell. In this manner, the mirror is pivotally secured to the central portion of the shell along the inner surface thereof.

A substantially rigid support arm is provided, and one end of the support arm is rigidly secured to the shell, preferably to the peripheral portion thereof the opposite end of the support arm includes a mounting pad in fixed relationship with the support arm. An adhesive layer is secured to the mounting pad for attaching the second end of the support arm to a portion of a motorcycle helmet or its associated face shield. Preferably, the mounting pad has at least one groove extending thereacross for allowing the mounting pad to bend about the at least one groove to conform to a curved portion of a motorcycle helmet and/or face shield. The mirror assembly may thereby be secured to a portion of a motorcycle helmet for allowing a motorcyclist to see the image reflected by the mirror.

In another aspect of the present invention, a motorcycle helmet assembly includes a motorcycle helmet for extending about the head of a motorcyclist. The motorcycle helmet has a facial opening formed therein for allowing a motorcyclist to observe the surroundings ahead. A transparent face shield is secured to the motorcycle helmet, and can be extended over the facial opening to shield the motorcyclist's face from wind and debris.

The motorcycle helmet assembly further includes a mirror assembly for a motorcycle helmet and including an elongated shell for housing a mirror. The shell includes a peripheral portion, preferably of generally rectangular shape. This peripheral portion surrounds a central portion of the shell which projects forwardly of the peripheral portion of the shell. The shell includes a forwardly-facing outer surface having a generally convex shape and an opposing rearwardly-facing inner surface having a generally concave shape that defines a partially-enclosed space.

The above-mentioned motorcycle helmet assembly further includes a mirror disposed within the partially enclosed space of the shell, and is coupled thereto, for reflecting an image of the view behind a motorcyclist. The mirror includes a mirrored surface that faces away from the inner surface of the shell. In the preferred embodiment, the mirror includes a backing that faces toward the inner surface of the shell. Ideally, the backing of the mirror and the inner surface of the shell are joined together by a ball and socket joint for securing the mirror within the partially enclosed space of the shell while permitting adjustment of the orientation of the mirror relative to the shell. In this manner, the mirror is pivotally secured to the central portion of the shell along the inner surface thereof.

The above-mentioned motorcycle helmet assembly further also includes a substantially rigid support arm having a first end rigidly secured to the shell, preferably to the outer surface of the shell. The second, opposing end of the support arm includes a mounting pad in fixed relationship with the support arm. An adhesive layer is secured to the mounting pad for adhesively securing the second end of the support arm to an upper portion of the transparent face shield for allowing a motorcyclist to see the image reflected by the mirror. Preferably, the mounting pad has at least one groove extending thereacross for allowing the mounting pad to bend about the at least one groove to conform to a curved portion of the face shield.

Ideally, the above-mentioned motorcycle helmet assembly further includes a second such mirror assembly, the second mirror assembly also being secured to the transparent face shield, but on an opposite side thereof to provide left-side and right-side rear view mirrors.

Another aspect of the present invention relates to a similar motorcycle helmet assembly, except that the motorcycle helmet does not include a face shield for extending over the facial opening of the helmet, as would be the case for a motocross helmet, for example. In this embodiment, the mounting pad of each mirror assembly is adhesively secured directly to the motorcycle helmet, rather than to a face shield, for allowing the motorcyclist to see the image reflected by such mirror. In the preferred form of this embodiment, a pair of such mirror assemblies are secured to opposite sides of the motorcycle helmet to provide left-side and right-side rear view mirrors.

### BRIEF DESCRIPTION OF THE DRAWINGS

FIG. 1 is a side view of a motorcycle rider wearing a helmet equipped with a flip-up face shield equipped with a mirror assembly in accordance with the present invention.

FIG. 2 is a perspective view of the mirror assembly included in FIG. 1.

FIG. 3 is a side view of the mirror assembly of FIG. 2.

FIG. 4 is an end view of the mirror assembly of FIG. 2.

FIG. 5 is a perspective view of a ribbed self-adhesive mounting pad used to secure the arm of the mirror assembly to a face shield or helmet.

FIG. 6 is an exploded sectional view of the mirror assembly illustrating a ball-and-socket joint used to secure the mirror within its protective housing.

FIG. 7 is a view looking outwardly through the face shield of a motorcycle helmet equipped with right- and left-hand mirror assemblies in accordance with the present invention.

FIG. 8 is a frontal view of a motorcycle rider wearing a helmet with a face shield equipped with right- and left-hand mirror assemblies in accordance with the present invention.

FIG. 9 is a perspective view of a motorcycle rider wearing a motocross helmet which omits any face shield, and equipped with right- and left-hand mirror assemblies secured directly to the helmet shell.

### DETAILED DESCRIPTION OF THE PREFERRED EMBODIMENT

In FIG. 1, motorcycle rider 20 is shown wearing a conventional helmet 22. Helmet 22 extends about the head of motorcyclist 20, and a facial opening is formed therein for allowing a motorcyclist to observe the surroundings ahead. A transparent face shield 24 is secured to helmet 22 and extends over the aforementioned facial opening to shield the motorcyclist's face and eyes. Face shield 24 is pivotally connected to helmet 22, and may be flipped up to the position indicated by dashed lines 24A, when cyclist 20 has stopped or dismounted from a motorcycle. A mirror assembly 26, constructed in accordance with a preferred embodiment of the present invention, is shown secured to face shield 24; when face shield 24 is flipped up to its raised position 24A, mirror assembly 26A also flips up to a raised position.

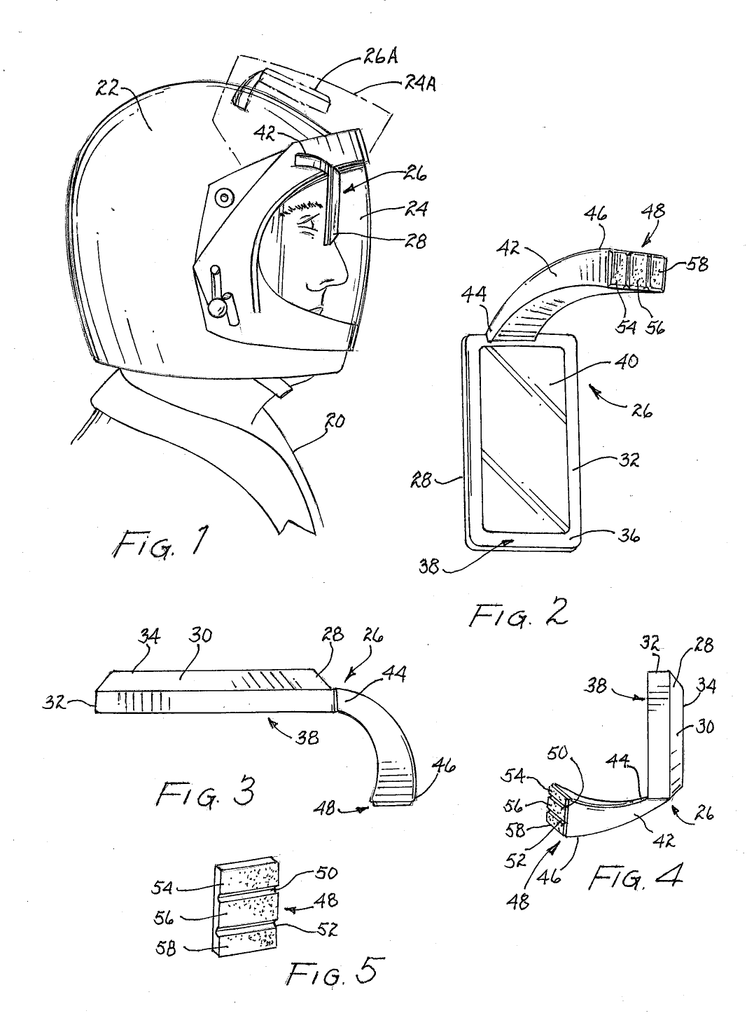

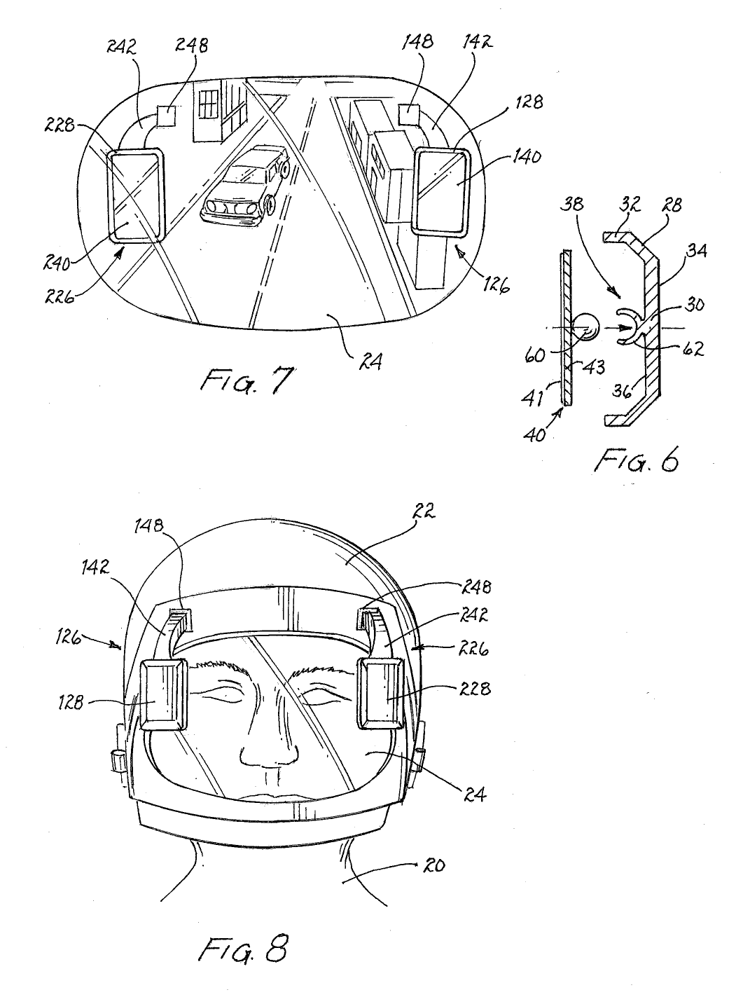

Referring now to FIGS. 2-4, mirror assembly 26 includes an elongated shell 28 which has a central portion 30 surrounded by a peripheral portion 32. Peripheral portion 32 of shell 28 preferably has a generally rectangular shape. Central portion 30 of shell 28 projects forwardly of peripheral portion 32 along a tapered contour to provide an aerodynamic profile, offering reduced wind resistance when cyclist 20 is riding at highway speeds. As shown best in FIG. 6, shell 28 includes a forwardly-facing outer surface 34 having a generally convex shape, and an opposing rearwardly-facing inner surface 36 having a generally concave shape. Rearwardly-facing inner surface 36 defines a partially-enclosed space 38.

A mirror 40 is coupled to shell 28 and disposed within partially enclosed space 38 thereof. Preferably, mirror 40 is secured to central portion 30 of shell 28 along inner surface 36 thereof. Mirror 40 serves to reflect an image of the view behind, and to one side of, motorcyclist 20. Mirror 40 includes a mirrored surface 41 facing away from inner surface 36 of shell 28; mirror 40 further includes a backing 43 facing toward inner surface 36 of shell 28. Backing 43 of mirror 40 includes a ball portion 60 projecting therefrom; inner surface 36 of shell 28 includes a mating socket portion 62 formed thereupon. Ball portion 60 snaps into, and is engaged by, socket 62 for pivotally securing mirror 40 within partially enclosed space 38 of shell 28 while permitting adjustment of the angular orientation of mirror 40 relative to shell 28. Those skilled in the art will appreciate that the relative positions of the ball portion and socket portion could be reversed, if desired, wherein the ball portion extends from the interior of shell 28, and the socket portion is formed upon backing 43 of mirror 40.

A substantially rigid arm 42 is provided to attach shell 28, and mirror 40, to face shield 24. Arm 42 has a first end 44 rigidly secured to shell 28, preferably to the top of peripheral portion 32 of shell 28. Shell 28 and arm 42 may both be made of a durable plastic material, and are preferably integrally molded to form a unitary structure. The second opposing end 46 of arm 42 terminates in a mounting pad 48. Mounting pad 48 is preferably in a fixed, generally non-movable, relationship with arm 42, as opposed to being pivotally connected thereto. Thus, when mounting pad 48 is secured to either face shield 24 or helmet 22, arm 42 is generally immovable relative to such face shield or helmet, respectively.

Mounting pad 48 of arm 42 is preferably secured to either face shield 24 or helmet 22 by a layer of adhesive. Preferably, a thin double-coated adhesive foam tape, of the type commercially available from 3M Corporation of St. Paul, Minn. is applied to mounting pad 48, and then to either face shield 24 or helmet 22. FIG. 5 is a closeup view of mounting pad 48, and showing how mounting pad 48 is preferably sub-divided by grooves 50 and 52 into three strips, each having their own adhesive layers 54, 56 and 58. Grooves 50 and 52 slightly weaken mounting pad 48, allowing it to flex and bend to a small degree about such grooves. This allows mounting pad 48 to better conform to the curved surfaces of face shield 24 or helmet 22 to form a more secure attachment between arm 42 and the face shield or helmet.

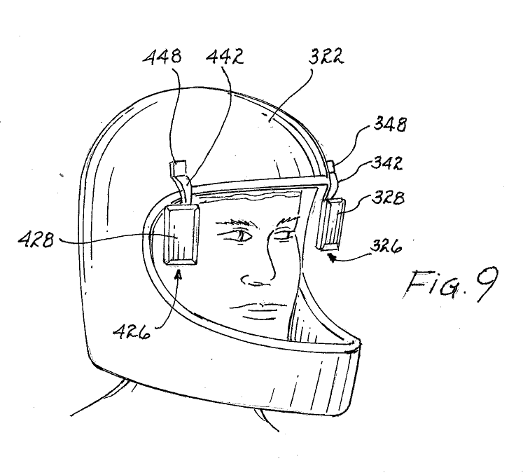

FIGS. 7 and 8 illustrate the use of a pair of such mirror assemblies, 126 and 226, secured to the face shield 24 of helmet 22. In FIG. 7, mirror assemblies 126 and 226 are shown as they would be seen by motorcyclist 20 as he or she looks out through face shield 24 of helmet 22. Cyclist 20 has a clear view ahead of oncoming traffic, but may also see the images reflected by left-side mirror 240 and right-side mirror 140 at the same time. In this manner, cyclist 20 is able to see the rear-view images reflected by both of such mirrors. As shown best in FIG. 8, mounting pads 148 and 248 of mirror assemblies 126 and 226 are adhesively secured to opposite sides of transparent face shield 24, preferably near the top of face shield 24, for allowing mirrors 140 and 240 to be positioned at eye level.

Prior to, and initially during installation of mirror assemblies 126 and 226, the adhesive affixed to the mounting pads is temporarily covered by a glossy, peel-away protective strip. The user places helmet 22 over his or her head, assumes the normal riding position on a motorcycle, and then holds the mirror assembly mounting pad against an upper portion of face shield 24 until the user can clearly see an image of the area behind the user. The peel-away protective strip is then removed, and the mounting pad is securely adhered to face shield 24. Final adjustments to the angular orientation of such mirrors are easily made by the user simply by moving mirrors 140 and 240 about their ball-and-socket joints within shells 128 and 228, respectively. Once such final angles are set, the mirrors are not easily dislodged from such desired settings by wind forces, since mirrors 140 and 240 are located behind, and within, shells 128 and 228. Moreover, because shells 128 and 228 are rigidly secured to face shield 24 by rigid support arms 142 and 242, mirrors 140 and 240 maintain their proper angular orientations, even when the motorcyclist is driving at high speeds.

Referring now to FIG. 9, an alternate embodiment is illustrated for a motocross helmet 322 used in off-road racing. Motocross helmets include a facial opening but typically omit any face shield to cover such opening. In this embodiment, mirror assemblies 326 and 426 are secured directly to helmet 322. Once again, shells 328 and 428 are preferably supported at eye level. Support arms 342 and 442 are adhesively secured by mounting pads 348 and 448, respectively, directly to helmet 322 just above the facial opening of helmet 322, on the left and right sides thereof. Mirror assemblies 326 and 426 otherwise function in the same manner previously described above for mirror assemblies 126 and 226, and allow the user to see behind, and to the sides, of the user without moving the user's head, and without losing sight of the path ahead.

Those skilled in the art will now appreciate that a simple and inexpensive mirror assembly for a motorcycle rider has been described that is easily secured to either a motorcycle helmet itself or to the face shield of a motorcycle helmet for allowing the rider to see both behind and to the side of the user. The disclosed mirror assembly does not require modification of either the motorcycle helmet or its associated face shield, and yet is easily secured to either such face shield, or to the helmet itself if there is no face shield present. The disclosed mirror assembly is not easily displaced by wind forces, even when a cyclist is riding at highway speeds, since the mirror is protected by the shell in which it is secured. Nonetheless, fine adjustments to the angular orientation of the mirror can be made quickly and easily following installation without the need for any tools. The disclosed mirror assembly can be manufactured simply and inexpensively, and enhances the user's ability to constantly be aware of traffic behind the rider.

While the present invention has been described with respect to preferred embodiments thereof, such description is for illustrative purposes only, and is not to be construed as limiting the scope of the invention. Various modifications and changes may be made to the described embodiments by those skilled in the art without departing from the true spirit and scope of the invention as defined by the appended claims.

I claim:

1. A mirror assembly for a motorcycle helmet, the mirror assembly comprising in combination:
a. an elongated shell, said shell including a central portion surrounded by a peripheral portion, the central portion of said shell projecting forwardly of the peripheral portion, said shell including a forwardly-facing outer surface having a generally convex shape and a rearwardly-facing inner surface having a generally concave shape, the rearwardly-facing inner surface defining a partially-enclosed space;
b. a mirror secured to said shell and disposed within the partially enclosed space of said shell for reflecting an image of the view behind a motorcyclist;
c. a substantially rigid arm having first and second opposing ends, the first end of said arm being rigidly secured to the peripheral portion of said shell, and the second end of said arm including a mounting pad, the mounting pad being in fixed relationship with said arm;
d. an adhesive layer secured to the mounting pad for attaching the second end of said arm to a portion of a motorcycle helmet;
whereby the mirror assembly may be secured via the mounting pad to a portion of a motorcycle helmet for allowing a motorcyclist to see the image reflected by the mirror.

2. The mirror assembly recited by claim 1 wherein the peripheral portion of said shell has a generally rectangular shape.

3. The mirror assembly recited by claim 1 wherein the mirror is secured to the central portion of said shell along the inner surface thereof.

4. The mirror assembly recited by claim 3 wherein the mirror includes a mirrored surface facing away from the inner surface of said shell, the mirror further including a backing facing toward the inner surface of said shell, the backing of the mirror including a ball portion projecting therefrom, and the inner surface of said shell including a socket portion formed thereupon, the ball portion of the backing being engaged by the socket portion of said shell for securing the mirror within the partially enclosed space of said shell while permitting adjustment of the orientation of the mirror relative to said shell.

5. The mirror assembly recited by claim 3 wherein the mirror includes a mirrored surface facing away from the inner surface of said shell, the mirror further including a backing facing toward the inner surface of said shell, the backing of the mirror including a socket portion formed thereupon, and the inner surface of said shell including a ball portion projecting therefrom, the ball portion of said shell being engaged by the socket portion of said backing for securing the mirror within the partially enclosed space of said shell while permitting adjustment of the orientation of the mirror relative to said shell.

6. The mirror assembly recited by claim 1 wherein the mounting pad has at least one groove extending thereacross for allowing the mounting pad to bend about the at least one groove to conform to a curved portion of a motorcycle helmet.

7. A motorcycle helmet assembly comprising in combination:
a. a motorcycle helmet for extending about the head of a motorcyclist, the motorcycle helmet having an opening formed therein for allowing a motorcyclist to observe the surroundings ahead;
b. a transparent face shield secured to the motorcycle helmet and extending over said opening to shield the motorcyclist's face;
c. a first mirror assembly, said first mirror assembly comprising:
i. an elongated shell, said shell including a central portion surrounded by a peripheral portion, the central portion of said shell projecting forwardly of the peripheral portion, said shell including a forwardly-facing outer surface having a generally convex shape and a rearwardly-facing inner surface having a generally concave shape, the rearwardly-facing inner surface defining a partially-enclosed space;
ii. a mirror secured to said shell and disposed within the partially enclosed space of said shell for reflecting an image of the view behind a motorcyclist;
iii. a substantially rigid arm having first and second opposing ends, the first end of said arm being rigidly secured to the outer surface of said shell, and the second end of said arm including a mounting pad, the mounting pad being in fixed relationship with said arm;
iv. an adhesive layer secured to the mounting pad;
d. the mounting pad of said first mirror assembly being adhesively secured to an upper portion of the transparent face shield for allowing a motorcyclist to see the image reflected by the mirror.

8. The mirror assembly recited by claim 7 wherein the peripheral portion of said shell has a generally rectangular shape.

9. The mirror assembly recited by claim 7 wherein the mirror is secured to the central portion of said shell along the inner surface thereof.

10. The mirror assembly recited by claim 9 wherein the mirror includes a mirrored surface facing away from the inner surface of said shell, the mirror further including a backing facing toward the inner surface of said shell, the backing of the mirror including a ball portion projecting therefrom, and the inner surface of said shell including a socket portion formed thereupon, the ball portion of the backing being engaged by the socket portion of said shell for securing the mirror within the partially enclosed space of said shell while permitting adjustment of the orientation of the mirror relative to said shell.

11. The mirror assembly recited by claim 9 wherein the mirror includes a mirrored surface facing away from the inner surface of said shell, the mirror further including a backing facing toward the inner surface of said shell, the backing of the mirror including a socket portion formed thereupon, and the inner surface of said shell including a ball portion projecting therefrom, the ball portion of said shell being engaged by the socket portion of said backing for securing the mirror within the partially enclosed space of said shell while permitting adjustment of the orientation of the mirror relative to said shell.

12. The mirror assembly recited by claim 7 wherein the mounting pad has at least one groove extending thereacross for allowing the mounting pad to bend about the at least one groove to conform to a curved portion of said transparent face shield.

13. The mirror assembly recited by claim 7 further including a second mirror assembly, said second mirror assembly comprising:
a. an elongated shell, said shell including a central portion surrounded by a peripheral portion, the central portion of said shell projecting forwardly of the peripheral portion, said shell including a forwardly-facing outer surface having a generally convex shape and a rearwardly-facing inner surface having a generally concave shape, the rearwardly-facing inner surface defining a partially-enclosed space;
b. a mirror secured to said shell and disposed within the partially enclosed space of said shell for reflecting an image of the view behind a motorcyclist;
c. a substantially rigid arm having first and second opposing ends, the first end of said arm being rigidly secured to the outer surface of said shell, and the second end of said arm including a mounting pad, the mounting pad being in fixed relationship with said arm;
d. an adhesive layer secured to the mounting pad;
e. the mounting pad of said second mirror assembly being adhesively secured to an upper portion of the transparent face shield for allowing a motorcyclist to see the image reflected by the mirror; and
f. the mounting pads of said first and second mirror assemblies being adhesively secured to opposite sides of the transparent face shield.

14. A motorcycle helmet assembly comprising in combination:
a. a motorcycle helmet for extending about the head of a motorcyclist, the motorcycle helmet having an opening formed therein for allowing a motorcyclist to observe the surroundings ahead;
b. a first mirror assembly, said first mirror assembly comprising:
i an elongated shell, said shell including a central portion surrounded by a peripheral portion, the central portion of said shell projecting forwardly of the peripheral portion, said shell including a forwardly-facing outer surface having a generally convex shape and a rearwardly-facing inner surface having a generally concave shape, the rearwardly-facing inner surface defining a partially-enclosed space;
ii. a mirror secured to said shell and disposed within the partially enclosed space of said shell for reflecting an image of the view behind a motorcyclist;
iii. a substantially rigid arm having first and second opposing ends, the first end of said arm being rigidly secured to the outer surface of said shell, and the second end of said arm including a mounting pad, the mounting pad being in fixed relationship with said arm;
iv. an adhesive layer secured to the mounting pad;
d. the mounting pad of said first mirror assembly being adhesively secured to the motorcycle helmet for allowing a motorcyclist to see the image reflected by the mirror.

15. The mirror assembly recited by claim 14 wherein the peripheral portion of said shell has a generally rectangular shape.

16. The mirror assembly recited by claim 14 wherein the mirror is secured to the central portion of said shell along the inner surface thereof.

17. The mirror assembly recited by claim 16 wherein the mirror includes a mirrored surface facing away from the inner surface of said shell, the mirror further including a backing facing toward the inner surface of said shell, the backing of the mirror including a ball portion projecting therefrom, and the inner surface of said shell including a socket portion formed thereupon, the ball portion of the backing being engaged by the socket portion of said shell for securing the mirror within the partially enclosed space of said shell while permitting adjustment of the orientation of the mirror relative to said shell.

18. The mirror assembly recited by claim 16 wherein the mirror includes a mirrored surface facing away from the inner surface of said shell, the mirror further including a backing facing toward the inner surface of said shell, the backing of the mirror including a socket portion formed thereupon, and the inner surface of said shell including a ball portion projecting therefrom, the ball portion of said shell being engaged by the socket portion of said backing for securing the mirror within the partially enclosed space of said shell while permitting adjustment of the orientation of the mirror relative to said shell.

19. The mirror assembly recited by claim 14 wherein the mounting pad has at least one groove extending thereacross for allowing the mounting pad to bend about the at least one groove to conform to a curved portion of said motorcycle helmet.

20. The mirror assembly recited by claim 14 further including a second mirror assembly, said second mirror assembly comprising:
a. an elongated shell, said shell including a central portion surrounded by a peripheral portion, the central portion of said shell projecting forwardly of the peripheral portion, said shell including a forwardly-facing outer surface having a generally convex shape and a rearwardly-facing inner surface having a generally concave shape, the rearwardly-facing inner surface defining a partially-enclosed space;
b. a mirror secured to said shell and disposed within the partially enclosed space of said shell for reflecting an image of the view behind a motorcyclist;
c. a substantially rigid arm having first and second opposing ends, the first end of said arm being rigidly secured to the outer surface of said shell, and the second end of said arm including a mounting pad, the mounting pad being in fixed relationship with said arm;
d. an adhesive layer secured to the mounting pad;
e. the mounting pad of said second mirror assembly being adhesively secured to the motorcycle helmet for allowing a motorcyclist to see the image reflected by the mirror; and
f. the mounting pads of said first and second mirror assemblies being adhesively secured to opposite sides of the motorcycle helmet.
